(19) United States
(12) Patent Application Publication
(10) Pub. No.: US 2015/0106513 A1
(43) Pub. Date: Apr. 16, 2015

(54) SYSTEM AND METHOD FOR OPERATING NETWORK TRAFFIC REDUCTION POLICY IN OVERLOADED AREA

(71) Applicant: IDEAWARE INC., Seongnam-si (KR)

(72) Inventor: Yang Myung CHA, Yongin-si (KR)

(73) Assignee: IDEAWARE INC., Seongnam-si (KR)

(21) Appl. No.: 14/503,155

(22) Filed: Sep. 30, 2014

(30) Foreign Application Priority Data
Oct. 14, 2013 (KR) 10-2013-0121934
Oct. 14, 2013 (KR) 10-2013-0121938

(51) Int. Cl. H04L 12/26

(52) U.S. Cl. CPC H04L 43/0876
USPC 709/224

(57) ABSTRACT

A system for operating network traffic reduction policy in an overloaded area includes a storage medium for storing policy agent identification information disposed at a wireless terminal apparatus in response to the wireless terminal apparatus identification information; a communication unit for receiving the wireless terminal apparatus identification information positioned at an overloaded area from a communication server; a confirmation unit for confirming the policy agent identification information disposed at the wireless terminal apparatus corresponding to the received wireless terminal apparatus identification information by the storage medium; and a processing unit for transmitting network usage cutoff policy information included with a timer for clearing network usage cutoff to policy agents corresponding to the policy agent identification information confirmed by the confirmation unit.

### BACKGROUND OF THE INVENTION

1. Technical Field

The present invention is to reduce network traffic in overloaded area by automatically cut-offing network connection of the applications for a wireless terminal apparatus positioned in the overloaded area.

2. Description of the Related Art

After supplying smart-phones, patterns using a wireless terminal apparatus for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

On the other hand, as shown in FIG. 2, main factors for mobile network jam include jam according to unnecessary network usage of the applications disposed at the wireless terminal apparatus, the jam according to a number of the wireless terminal apparatus driven to defined areas such as stadiums, subways, etc., and the jam according to usage patterns of the user.

Data communication is delayed according to rapid increase of network availability for a specific area in the case that a number of the wireless terminal apparatus are driven to the defined areas such as stadiums, subways, etc. Therefore, there is a problem in that the applications disposed at the wireless terminal apparatus further increase network traffic while continuously performing network connection for data communication connection on a second basis.

In order to solve much cost consumption of the mobile communication company due to network jam and service dissatisfaction for users of the wireless terminal apparatus, a method for controlling the network connection by a plurality of applications disposed at the wireless terminal apparatus is absolutely needed, but there are no solutions for this.

### SUMMARY OF THE INVENTION

According to an aspect of the invention, there is provided a system for operating network traffic reduction policy in an overloaded area, including a storage medium for connecting and storing a wireless terminal apparatus identification information and policy agent identification information disposed at the wireless terminal apparatus, a communication unit for receiving a user's wireless terminal apparatus identification information positioned at the overloaded area from a server on a communication network, a confirmation unit for confirming the policy agent identification information disposed at the wireless terminal apparatus in response to the received wireless terminal apparatus identification information by the storage medium, and a processing unit for transmitting network usage cutoff policy information included with a timer for clearing network usage cutoff to policy agents corresponding to the policy agent identification information confirmed by the confirmation unit.

It is preferable that the communication unit receives the user's wireless terminal apparatus identification information deviated or cleared from the overloaded area from the server on the communication network, the confirmation confirms the policy agent identification information disposed at the wireless terminal apparatus in response to the received wireless terminal apparatus identification information by the storage medium, and the processing unit transmits the policy information for clearing the network usage cutoff to the policy agents corresponding to the policy agent identification information confirmed by the confirmation unit within time, set to the timer for clearing the network usage cutoff, transmitted to the policy agents.

It is preferable that the processing unit transmits the application identification information allowing the network usage irrespective the position of the wireless terminal apparatus in the overloaded area to the policy agents.

According to another aspect of the invention, there is provided a method for operating network traffic reduction policy in an overloaded area, including confirming policy agent identification information disposed at the wireless terminal apparatus in response to the user's wireless terminal apparatus identification information positioned in an overloaded area through a storage medium connecting and storing a wireless terminal apparatus identification information and policy agent identification information disposed at the wireless terminal apparatus by a policy server, transmitting network usage cutoff policy information included with a timer for clearing network usage cutoff to the policy agents corresponding to the confirmed policy agent identification information by the policy server, and transmitting the policy information for clearing the network usage cutoff to the policy agents, in case of further receiving at least one of the user's wireless terminal apparatus identification information deviated from the overloaded area from a server on a communication network and the user's wireless terminal apparatus identification information positioned at the area at the time of clearing overload at the overloaded area, within time set to the timer for clearing the network usage cutoff.

It is preferable that the method for operating network traffic reduction policy in the overloaded area further includes transmitting application identification information allowing the network usage irrespective of the position of it in the overloaded area to the policy agents.

Further, the present invention includes a computer-readable recording medium for recording programs to execute each step.

Further, it is preferable that network usage cutoff policy information includes the policy information for cut-offing network connection for the remaining all applications, except for pre-defined specific applications, of a plurality of network usage applications disposed at the wireless terminal apparatus.

According to further another aspect of the invention, there is provided a method for operating network traffic reduction policy in an overloaded area, including confirming policy agent identification information disposed at the wireless terminal apparatus in response to the user's wireless terminal apparatus identification information positioned in an overloaded area through a storage medium connecting and storing a wireless terminal apparatus identification information and policy agent identification information disposed at the wireless terminal apparatus by a policy server, transmitting network usage cutoff policy information included with a timer for clearing network usage cutoff to the policy agents corresponding to the confirmed policy agent identification information by the policy server, cut-offing the network connection for the remaining all applications, except for the applications corresponding to the application identification information allowing the preset network usage, of a plurality of network usage applications based on the network usage cutoff policy information by the policy agents, transmitting the policy information for clearing the network usage cutoff to the policy agents, in case of receiving at least one of the user's wireless terminal apparatus identification information deviated from the overloaded area from a server on a communication network and the user's wireless terminal apparatus identification information positioned at the area at the time of clearing overload at the overloaded area by the policy server, within time set by the timer for clearing the network usage cutoff, clearing the network connection cutoff for the applications based on the received policy information for clearing the network usage cutoff by the policy agents, and clearing the network connection cutoff for the applications by the policy agents disposed at the wireless terminal apparatus on arriving on the time set to the timer for clearing the network usage cutoff, in case of not receiving at least one of the user's wireless terminal apparatus identification information deviated from the overloaded area from the server on the communication network or the user's wireless terminal apparatus identification information positioned at the area at the time of clearing overload in the overloaded area, within the time set to the timer for clearing the network usage cutoff.

According to further yet another aspect of the invention, there is provided a method for operating network traffic reduction policy in an overloaded area, including confirming policy agent identification information disposed at the wireless terminal apparatus in response to the user's wireless terminal apparatus identification information positioned in an overloaded area through a storage medium connecting and storing a wireless terminal apparatus identification information and policy agent identification information disposed at the wireless terminal apparatus by a policy server, transmitting network usage cutoff policy information included with a timer for clearing network usage cutoff to the policy agents corresponding to the confirmed policy agent identification information by the policy server, cut-offing the network connection for the remaining all applications, except for the applications corresponding to the application identification information allowing the preset network usage, of a plurality of network usage applications based on the network usage cutoff policy information by the policy agents, confirming the current position information by the policy agents and therefore confirms whether the current position deviates from an overloaded area, clearing the network connection cutoff for the applications by the policy agents disposed at the wireless terminal apparatus before reaching on time set to the timer for clearing the network usage cutoff, when the current position deviates from the overloaded area, after the confirming, and clearing the network connection cutoff for the applications on reaching on time set by the timer for clearing the network usage cutoff, when the current position does not deviate from the overloaded area, after the confirming.

It is preferable that the method for operating network traffic reduction policy in the overloaded area further includes transmitting the application identification information allowing the network usage irrespective the position of the wireless terminal apparatus in the overloaded area to the policy agents by the policy server, and storing the application identification information allowing the network usage irrespective the position of the wireless terminal apparatus in the overloaded area into the storage region by the policy agents.

### BRIEF DESCRIPTION OF THE DRAWINGS

The following drawing drawings attached to the present specification illustrates an exemplary embodiment of the invention, and serves to further understand the technical idea of the invention along with a detailed description of the invention. Therefore, the invention is not limited to matters described in the drawings.

FIG. 1 shows mobile (wireless) data traffic indexes.

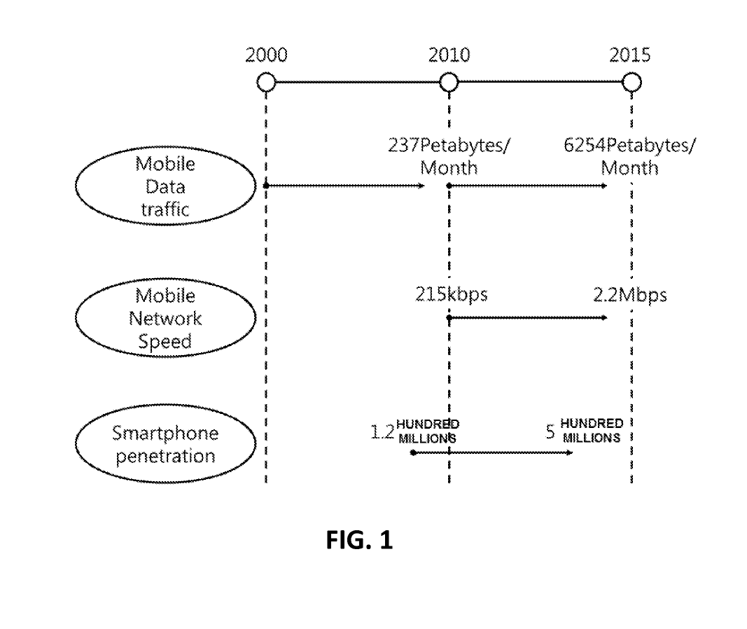

FIG. 2 shows main factors that may cause network jam at a prior wireless terminal apparatus.

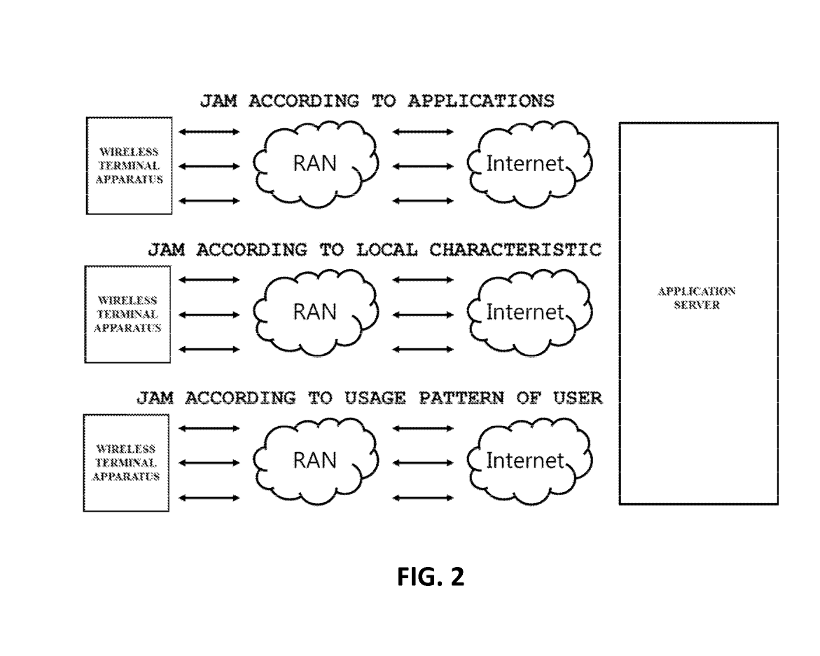

FIG. 3 shows a communication network or network connection according to an embodiment of the present invention.

FIG. 4 shows sub-configurations for a policy server according to the embodiment of the present invention.

FIG. 5 shows sub-configurations for a wireless terminal apparatus according to the embodiment of the present invention.

FIG. 6 shows a network usage cutoff policy operation process in an overloaded area according to the embodiment of the present invention.

FIG. 7 shows a network connection cutoff process for the wireless terminal apparatus positioned in the overloaded area according to the embodiment of the present invention.

FIG. 8 shows a policy operation process for clearing network usage cutoff in an overload clearing area according to the embodiment of the present invention.

FIG. 9 shows a process for clearing network connection cutoff for the wireless terminal apparatus deviated or cleared from the overload area according to the embodiment of the present invention.

FIG. 10 shows a network connection cutoff process for the wireless terminal apparatus deviated from the overloaded area according to another embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

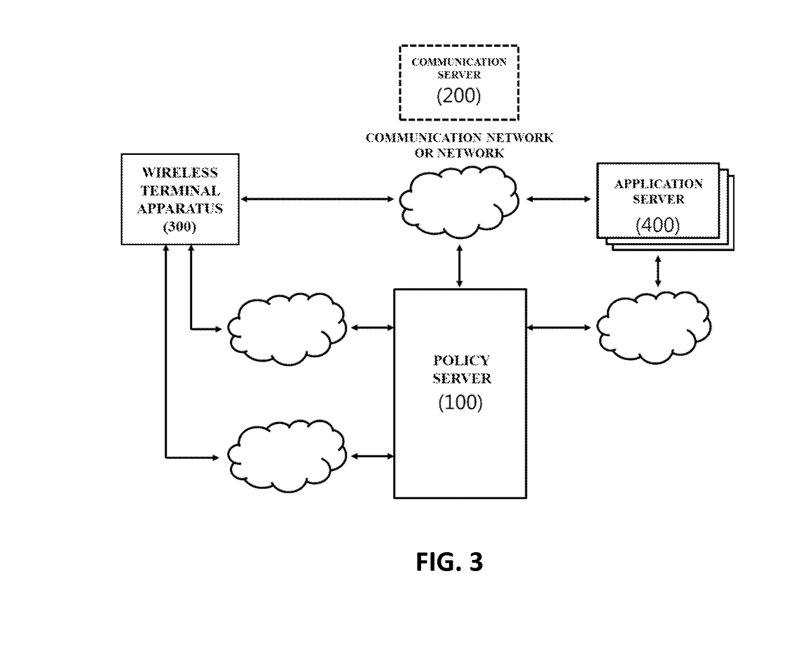

FIG. 3 shows a communication network or network connection according to an embodiment of the present invention.

In more detail, FIG. 3 shows configurations that a user's wireless terminal apparatus 300 are connected to a policy server 100 and a communication server 200 through a communication network or a network to control network connection of applications for the wireless terminal apparatus 300 positioned in the overloaded area.

The policy server 100 of the present invention confirms policy agent identification information disposed at the wireless terminal apparatus 300 in response to the user's wireless terminal apparatus 300 identification information positioned in the overloaded area through a storage medium 130 connecting and storing the wireless terminal apparatus 300 identification information and policy agent identification information disposed at the wireless terminal apparatus 300, and then transmits network usage cutoff policy information included with a timer for clearing network usage cutoff to policy agents corresponding to the confirmed policy agent identification information, on receiving the user's wireless terminal apparatus 300 identification information positioned in the overloaded area from a communication server 200 on a communication network.

The timer for clearing network usage cutoff is a timer that is set to autonomously clear network usage cutoff policies as constant time passes. The network usage cutoff policy information includes the policy information for cut-offing network connection for the remaining all applications, except for pre-defined specific applications, of a plurality of network usage applications disposed at the wireless terminal apparatus 300.

The policy server 100 of the present invention receives the user's wireless terminal apparatus 300 identification information deviated or cleared from the overloaded area from the communication server 200 on the communication network, confirms the policy agent identification information disposed at the wireless terminal apparatus 300 in response to the received wireless terminal apparatus 300 identification information through the storage medium 130, transmits policy information for clearing network usage cutoff to the policy agents corresponding to the confirmed policy agent identification information within time set to timer for clearing the network usage cutoff, and transmits application identification information allowing network usage irrespective of the position of it in the overloaded area to the policy agents.

The communication server 200 in the embodiment of the present invention relays data communication between the wireless terminal apparatus 300 and an application server, confirms whether the wireless terminal apparatus 300 is in the overloaded area, and transmits the wireless terminal apparatus 300 identification information positioned in the overloaded area to the policy server 100, in the case that the wireless terminal apparatus 300 is in the overloaded area, after the confirming.

The communication server 200 confirms whether the wireless terminal apparatus 300 positioned in the overloaded area is deviated or cleared from the overloaded area, and transmits the wireless terminal apparatus 300 identification information deviated or cleared from the overloaded area to the policy server 100, in case of deviating or clearing from the overloaded area, after the confirming.

The wireless terminal apparatus 300 in the embodiment of the present invention performs the network connection to the application server, includes policy agents and therefore receives the network usage cutoff policy information, included with the timer for clearing network usage cutoff, received from the policy server 100 by the policy agents, cutoffs the network connection for the applications disposed at the wireless terminal apparatus 300 based on the received network usage cutoff policy information, clears network connection cutoff for the applications on arriving on time set to the timer for clearing network usage cutoff, and therefore autonomously controls the network connection (or background call connection, etc.) for a plurality of applications disposed at the wireless terminal apparatus 300.

Further, the wireless terminal apparatus 300 in advance stores the application identification information allowing the network usage irrespective of the position of it in the overloaded area into a storage region 330, and excludes the applications, corresponding to the application identification information allowing the network usage pre-stored in the storage region 330, of a plurality of network usage applications on performing the network usage cutoff policy information received from the policy server 100 according to the position of it in the overloaded area.

Further, the wireless terminal apparatus 300 cutoffs the network connection for the remaining all applications, except for the applications corresponding to the application identification information allowing the network usage pre-stored in the storage region 330, of a plurality of network usage applications based on the network usage cutoff policy information, confirms the current position information and therefore confirms whether the current position deviates from an overloaded area, clears the network connection cutoff for the applications by the policy agents disposed at the wireless terminal apparatus 300 before reaching on time set to a timer for clearing the network usage cutoff, when the current position deviates from the overloaded area, after the confirming, and clears the network connection cutoff for the applications on reaching on the time set to the timer for clearing the network usage cutoff, when the current position does not deviate from the overloaded area, after the confirming, thereby to autonomously clear the network connection cutoff for the applications disposed at the wireless terminal apparatus 300 without communicating with the server.

According to the present invention, the wireless terminal apparatus 300 include all terminal apparatuses, capable of wirelessly communicating, such as a mobile phone, a smart-phone, a tablet PC, etc.

The application server 400 in the present invention transceives data on performing the network connection for the applications disposed at the user's wireless terminal apparatus 300.

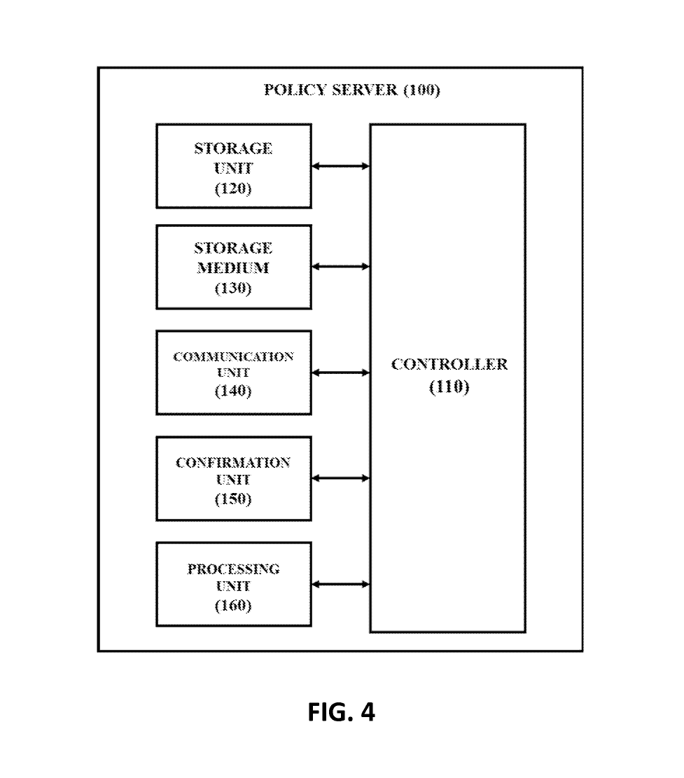

FIG. 4 shows sub-configurations of the policy server 100 according to an embodiment of the present invention.

FIG. 4 shows sub-configurations of the policy server 100 on the system for operating the network traffic reduction policy shown in FIG. 3, each configuration is to describe an embodiment of the present invention, and the present invention is not limited to the embodiment only shown in FIG. 4.

Referring to FIG. 4, the policy server 100 in the embodiment of the present invention includes a storage unit 120, a storage medium 130, a communication unit 140, a confirmation unit 150, a processing unit 160, and a controller 110 for controlling each configuration.

The policy server 100 is shown as a single server in the drawing for the description of the embodiments, but each means or configuration may be separated into at least one server.

Referring to FIG. 4, the storage unit 120 connects a plurality of the wireless terminal apparatus 300 identification information and each policy agent identification information disposed at the plurality of wireless terminal apparatus 300 and therefore stores the connected them into the storage medium 130.

The storage unit 120 in the present invention stores various information or data, except for the wireless terminal apparatus 300 identification information and the policy agent identification information, transceived to/from the communication server 200 and the user's the wireless terminal apparatus 300 into the storage medium 130 or database.

The wireless terminal apparatus 300 identification information may include at least one of the wireless terminal apparatus 300 serial number and the identification number for the wireless terminals 300 subscriber (or the user), and the policy agent identification information may include agent's serial ID or number, respectively.

The storage medium 130 in the embodiment of the present invention connects a plurality of the wireless terminal apparatus 300 identification information and each policy agent identification information disposed at the plurality of wireless terminal apparatus 300 and therefore stores the connected them into the storage medium.

According to the present invention, the storage medium 130 may be disposed at third server, not the policy server 100, and may be disposed at the communication server 200.

The communication unit 140 in the embodiment of the present invention receives the user's wireless terminals 300 identification information positioned at the overloaded area from the communication server 200 on the communication network.

Further, the communication unit 140 transceives various information or data to the communication server 200 or the user's wireless terminal apparatus 300.

For example, the communication unit 140 receives the user's wireless terminal apparatus 300 identification information deviated or cleared from the overloaded area from the communication server 200 on the communication network, and transmits the application identification information allowing the network usage irrespective of position of it in the overloaded area to the policy agents disposed at the wireless terminal apparatus 300.

The confirmation unit 150 in the embodiment of the present invention confirms the policy agent identification information disposed at the wireless terminal apparatus 300 in response to the user's wireless terminal apparatus 300 identification information, positioned at the overloaded area, received by the communication unit 140 through the storage medium 130.

According to the present invention, the confirmation unit 150 confirms the policy agent identification information disposed at the wireless terminal apparatus 300 in response to the received wireless terminal apparatus 300 identification information through the storage medium 130 in case of receiving the user's wireless terminal apparatus 300 identification information deviated or cleared from the overloaded area from the communication server 200 on the communication network by the communication unit 140.

The processing unit 160 in the embodiment of the present invention transmits the network usage cutoff policy information included with the timer for clearing the network usage cutoff to the policy agents corresponding to the policy information identification information confirmed by the confirmation unit 150.

The timer for clearing the network usage cutoff is a timer that is set to autonomously clear network usage cutoff policies as constant time passes. The network usage cutoff policy information includes the policy information for cut-offing the network connection for the remaining all applications, except for predefined specific applications, of a plurality of network usage applications disposed at the wireless terminal apparatus 300.

Further, the processing unit 160 transmits the application identification information allowing the network usage irrespective of the position of it in the overloaded area to the policy agents, and transmits the policy information for clearing the network usage cutoff to the policy agents, when the user's wireless terminal apparatus 300 positioned in the overloaded area is deviated or cleared from the overloaded area, within the time set to the timer for clearing the network usage cutoff.

In the present invention, wholly or in part of functions for each configuration disposed at the policy server 100 may be implemented by programs or program sets to execute the above-described processes by a computer.

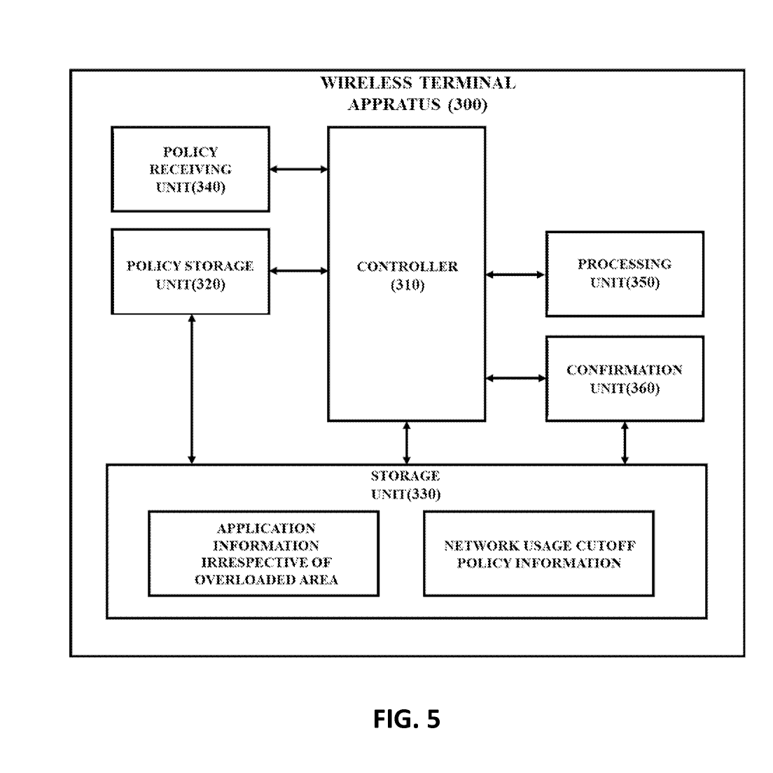

FIG. 5 shows sub-configurations of the wireless terminal apparatus 300 according to an embodiment of the present invention.

FIG. 5 shows sub-configurations for the wireless terminal apparatus 300 shown in FIG. 3, each configuration is to describe an embodiment of the present invention, and the present invention is not limited to the embodiment only shown in FIG. 5.

Referring to FIG. 5, the wireless terminal apparatus 300 in the embodiment of the present invention includes a policy receipt unit 340, a policy storage unit 320, a storage region 330, a processing unit 350, a confirmation unit 360, and a controller 310 for controlling each configuration.

Wholly or in part of each configuration of the wireless terminal apparatus 300 may be configured in a program type such as policy agents.

Referring to FIG. 5, the policy receipt unit 340 receives the application identification information allowing the network usage irrespective of the position of it in the overloaded area, and receives various information such as the network usage cutoff policy information included with the timer for clearing the network usage cutoff and the policy information for clearing the network usage cutoff from the policy server 100.

The policy storage unit 320 in the embodiment of the present invention stores the application identification information allowing the network usage, irrespective of the position of it in the overloaded area, received by the policy receipt unit 340 into the storage region 330.

The policy storage region 320 in the present invention stores the network usage cutoff policy information and the policy information for clearing the network usage cutoff, except for the application identification information allowing the network usage irrespective of the position of it in the overloaded area, into the storage region 330.

The storage region 330 in the embodiment of the present invention stores and manages the application identification information allowing the network usage irrespective of the position of it in the overloaded area.

Further, the storage region 330 stores the network usage cutoff policy information or the policy information for clearing the network usage cutoff, except for the application identification information allowing the network usage irrespective of the position of it in the overloaded area.

The processing unit 350 in the embodiment of the present invention cutoffs the network connection for the remaining all applications, except for the applications corresponding to the application identification information allowing the network usage pre-stored in the storage region 330, of a plurality of network usage applications based on the network usage cutoff policy information received by the policy receipt unit 340, and clears the network connection cutoff for the applications on arriving on the time set to the timer for clearing the network usage cutoff.

Further, the processing unit 350 clears the network connection cutoff for the applications based on the received policy information for clearing the network usage cutoff on receiving the policy information for clearing the network usage cutoff from the policy server 100 on the communication network by the policy receipt unit 340 before arriving on the time set to the timer for clearing the network usage cutoff.

The confirmation unit 360 in the embodiment of the present invention confirms the current position information and confirms whether the wireless terminal apparatus 300 is deviated from the overloaded area.

The processing unit 350 in the present invention clears the network connection cutoff for the applications disposed at the wireless terminal apparatus 300 before arriving on the time set to the timer for clearing the network usage cutoff, in the case that the current position is deviated from the overloaded area, according to the confirming performed by the confirmation unit 360.

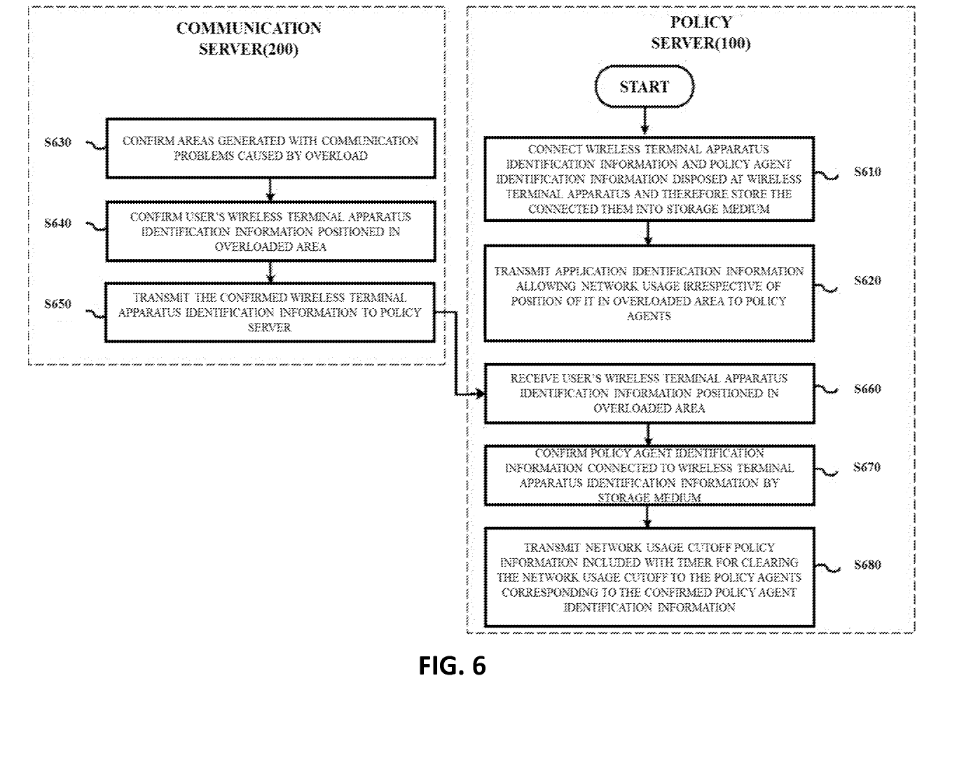

FIG. 6 shows a process for operating network usage cutoff policies in the overloaded area according to the embodiment of the present invention.

Firstly, the policy server 100 connects a plurality of wireless terminal apparatus 300 identification information and each policy agent identification information disposed at the plurality of wireless terminal apparatus 300 by the storage unit 120 and therefore stores the connected them into the storage medium 130 (S610).

Then, the policy server 100 transmits the application identification information allowing the network usage irrespective of the position of it in the overloaded area to the policy agents disposed at the wireless terminal apparatus 300 by the processing unit 160, and stores the application identification information allowing the network usage irrespective of the position of it in the overloaded area into the storage region by the policy agents (S620).

Orders for the steps S610 and S620 may be changed.

The communication server 200 in the present invention confirms areas generated with communication problems caused by overload on the communication network or network (S630), and then confirms the user's wireless terminal apparatus 300 identification information positioned in the overloaded area (S640).

The communication server 200 may confirm the position of the wireless terminal apparatus 300 using the wireless terminal apparatus 300 information connected to a base station and/or an exchange office at step S640.

When the wireless terminal apparatus 300 is positioned in the overloaded area at step S640, the communication server 200 transmits the wireless terminal apparatus 300 identification information positioned in the overloaded area to the policy server 100 (S650).

The policy server 100 receives the user's wireless terminal apparatus 300 identification information positioned in the overloaded area from the communication server 200 through the communication unit 140 (S660).

The confirmation unit 150 in the policy server 100 confirms the policy agent identification information disposed at the wireless terminal apparatus 300 in response to the user's wireless terminal apparatus 300 identification information, positioned in the overloaded area, received by the communication unit 140 through the storage medium 130 (S670).

Then, the policy server 100 transmits the network usage cutoff policy information included with the timer for clearing the network usage cutoff to the policy agents corresponding to the policy agent identification information confirmed by the confirmation unit 150 through the processing unit 160 (S680).

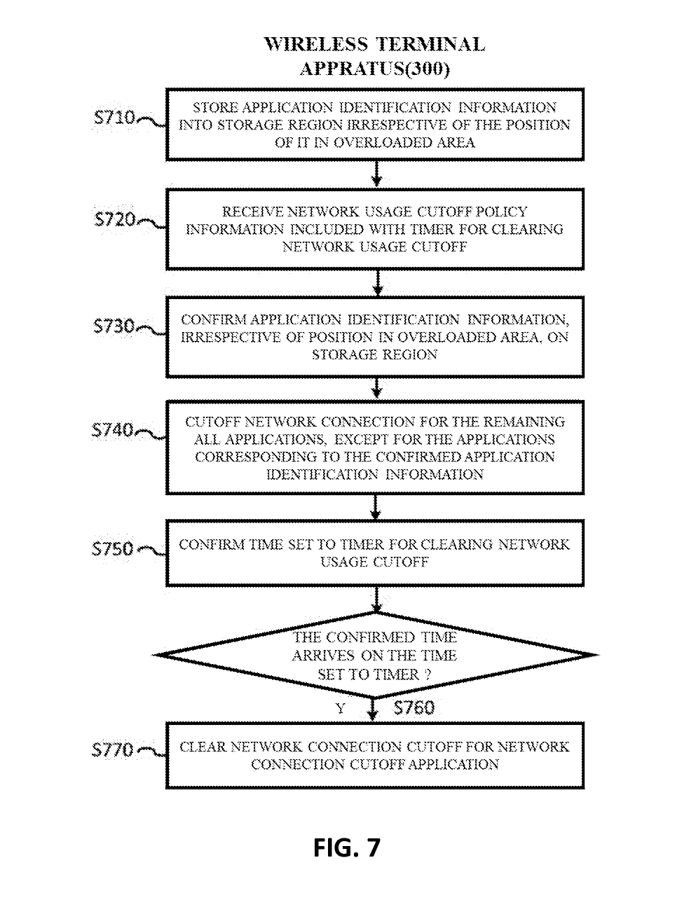

FIG. 7 shows a process for cut-offing the network connection for the wireless terminal apparatus positioned in the overloaded area according to the embodiment of the present invention.

The policy agents in the wireless terminal apparatus 300 receive the application identification information allowing the network usage, irrespective of the position of it in the overloaded area, transmitted by the policy server 100 and therefore stores the received information into the storage region 330 (S710).

The policy agents in the wireless terminal apparatus 300 receive the network usage cutoff policy information included with the timer for clearing the network usage cutoff from the policy server 100 (S720), and confirms the applications corresponding to the application identification information allowing the network usage pre-stored in the storage region 330 of a plurality of network usage applications (S730).

Then, the policy agents in the wireless terminal apparatus 300 cutoff the network connection for the remaining all applications, except for the applications corresponding to the application identification information allowing the network usage pre-stored in the storage region 330, of a plurality of network usage applications based on the received network usage cutoff policy information included with the timer for clearing the network usage cutoff (S740).

Then, the policy agents in the wireless terminal apparatus 300 confirms the time set to the timer for clearing the network usage cutoff, and therefore confirms whether the confirmed time arrives on the time for clearing the network usage cutoff (S750).

The wireless terminal apparatus 300 policy agents clear the network connection cutoff for the applications (S770), when the confirmed time arrives on the time for clearing the network usage cutoff (S760), after the confirming at step S750.

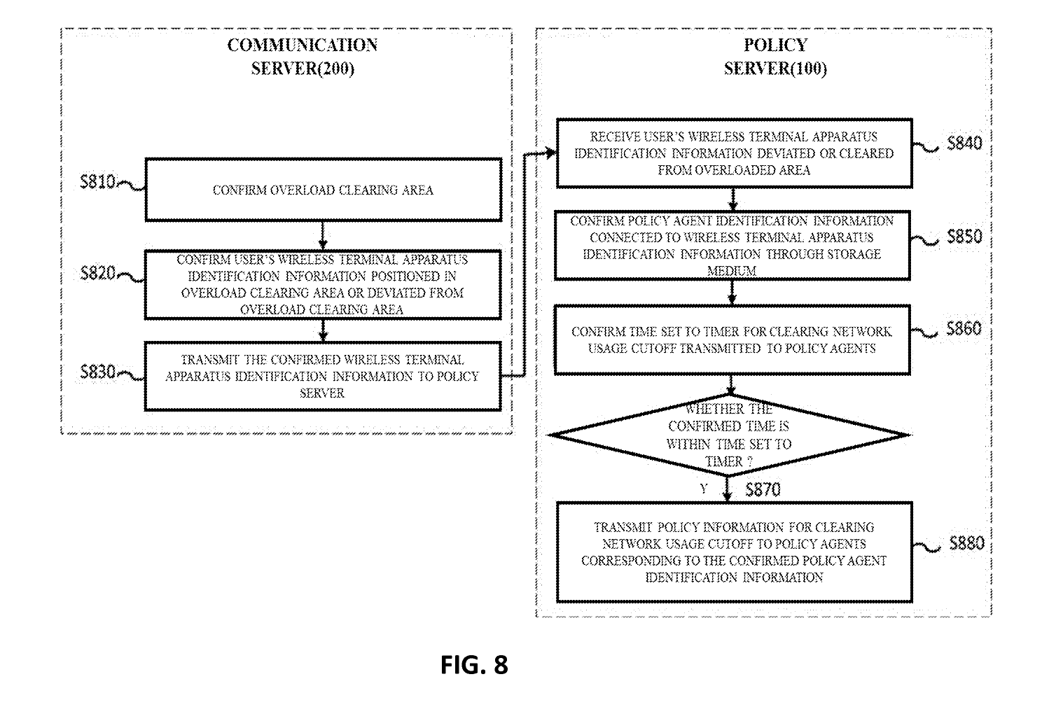

FIG. 8 shows a process for operating the policies clearing the network usage cutoff in the overload clearing area according to the embodiment of the present invention.

The communication server 200 in the present invention confirms the overload clearing area (S810), and confirms the user's wireless terminal apparatus identification information positioned in the overload clearing area or deviated from the overload clearing area (S820).

Then, the communication server 200 transmits the wireless terminal apparatus 300 identification information, deviated or cleared from the overloaded area, confirmed at step S820 to the policy server 100 (S830).

The policy server 100 receives the user's wireless terminal apparatus 300 identification information deviated or cleared from the overloaded area from the communication server 200 through the communication unit 140 (S840).

The confirmation unit 150 in the policy server 100 confirms the policy agent identification information disposed at the wireless terminal apparatus 300 in response to the user's wireless terminal apparatus 300 identification information, deviated or cleared from the overloaded area, received by the communication unit 140 through the storage medium 130 (S850), and the policy server 100 confirms the time set to the timer for clearing the network usage cutoff transmitted to the policy agents (S860).

The policy server 100 transmits the policy information for clearing the network usage cutoff to the policy agents corresponding to the policy agent identification information confirmed by the confirmation unit 150 through the processing unit 160 (S880), when the confirmed time is within the time, set to the timer for clearing the network usage cutoff (S870), transmitted to the policy agents, after the confirming performed by step S860.

Orders for the steps S850 and S860 may be changed. The steps S850 and S880 may be omitted, when the time set by the timer for clearing the network usage cutoff already transmitted to the policy agents passes, after the confirming at step S860.

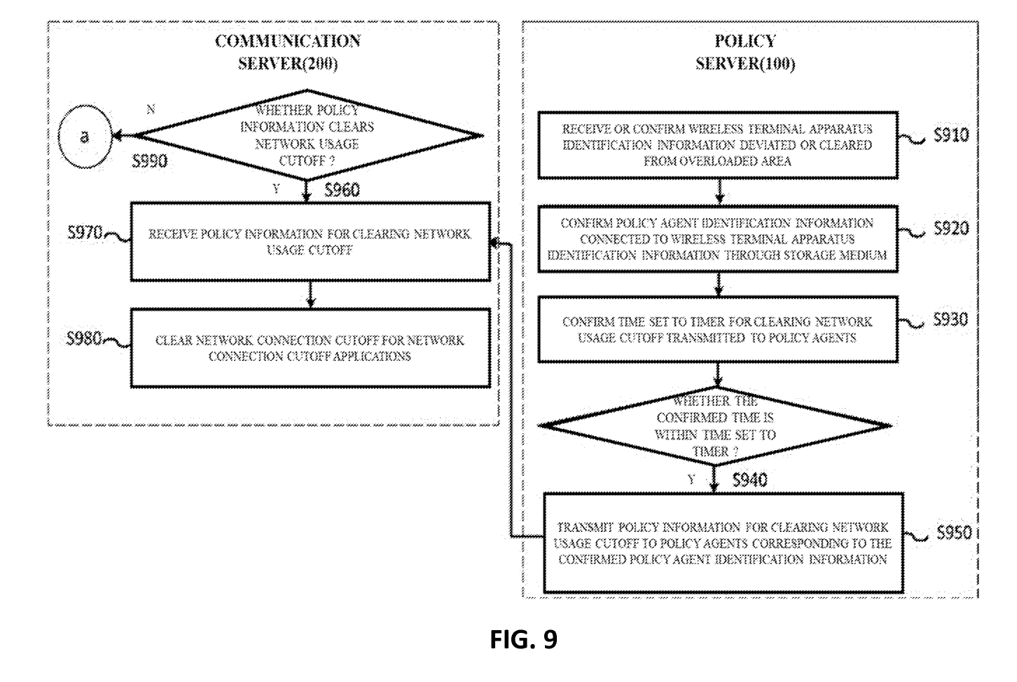

FIG. 9 shows a process for clearing network connection cutoff for the wireless terminal apparatus deviated or cleared from the overloaded area according to the embodiment of the present invention.

The policy server 100 in the present invention receives or directly confirms the user's wireless terminal apparatus 300 identification information deviated or cleared from the overloaded area from the communication server (S910).

To confirm whether the wireless terminal apparatus 300 positioned at the overloaded area is deviated or cleared from the overloaded area by the communication server 200 or the policy server 100 at step S910 may confirm the position of the wireless terminal apparatus 300 and whether it is deviated or cleared from the overloaded area, using the wireless terminal apparatus 300 information connected to the base station and/or the exchange office.

Then, the policy server 100 confirms the policy agent identification information disposed at the wireless terminal apparatus 300 in response to the user's wireless terminal apparatus 300 identification information deviated or cleared from the received or confirmed overload area through the storage medium (S920), and confirms the time set to the timer for clearing the network usage cutoff transmitted to the policy agents (S930).

The policy server 100 transmits the policy information for clearing the network usage cutoff to the policy agents corresponding to the policy agent identification information confirmed by the confirmation unit 150 through the processing unit 160 (S950), when the confirmed time is within the time, set to the timer for clearing the network usage cutoff, transmitted to the policy agents (S940), after the confirming performed by step S930.

Orders for the steps S920 and S930 may be changed. The steps S920 and S950 may be omitted, when the time set by the timer for clearing the network usage cutoff already transmitted to the policy agents passes, after the confirming at step S930.

The policy agents disposed at the wireless terminal apparatus 300 receive the policy information for clearing the network usage cutoff transmitted from the policy server 100 (S970) and clear the network connection cutoff for the applications based on the received policy information for clearing the network usage cutoff (S980), in case of clearing the network usage cutoff by the policy information for clearing the network usage cutoff (S960).

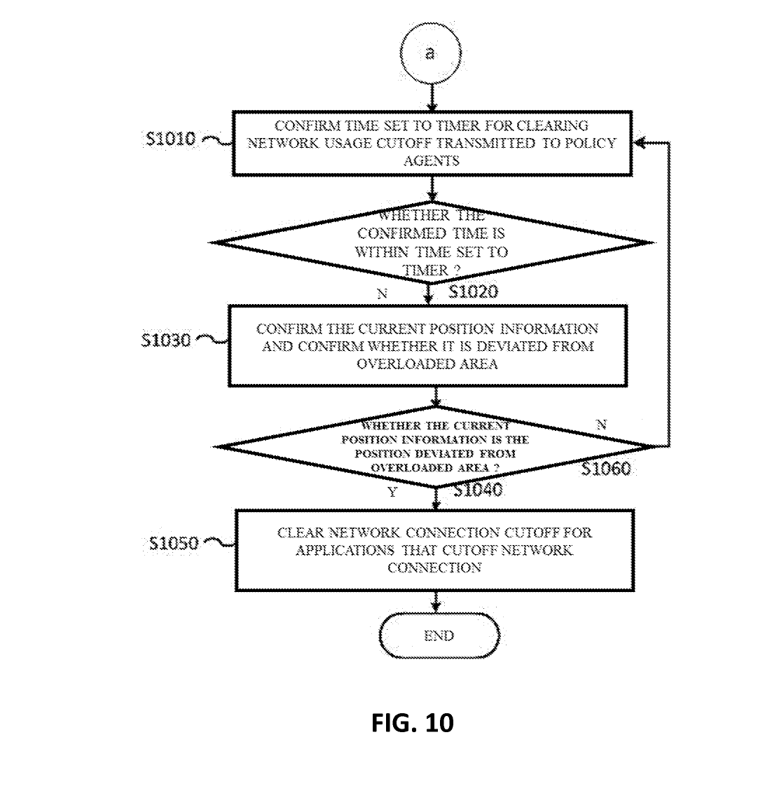

A process (S990) for autonomously clearing the network usage cutoff, not using the policy information for clearing the network usage cutoff, by the policy agents disposed at the wireless terminal apparatus 300 is described in FIG. 10.

FIG. 10 shows a process for cut-offing the network connection for the wireless terminal apparatus deviated from the overloaded area according to the embodiment of the present invention.

The policy agents disposed at the wireless terminal apparatus 300 confirm the time set to the timer for clearing the network usage cutoff in case of autonomously clearing the network usage cutoff (S1010), not using the policy information for clearing the network usage cutoff.

The wireless terminal apparatus 300 policy agents confirm the current position information of the wireless terminal apparatus 300 using GPS information or the base station information and therefore confirm whether it is deviated from the overloaded area (S1030), when the confirmed time does not arrive on the time set by the timer for clearing the network usage cutoff transmitted to the policy agents (S1020), after the confirming at step S1010.

The wireless terminal apparatus 300 policy agents clear the network connection cutoff for the applications that cutoff the network connection according to the position of it in the overloaded area (S1050) when the current position information is the position deviated or cleared from the overloaded area at step S1030 (S1040).

The wireless terminal apparatus 300 policy agents repeat the steps S1010 to S1030 when the current position information is not the position deviated or cleared from the overloaded area at step S1030 (S1060).

According to an embodiment of the present invention, the network usage cutoff policy information, including the timer for clearing the network usage cutoff, further comprising traffic level information for the wireless terminal apparatus 300. Using the traffic level information, the wireless terminal apparatus 300 cutoffs the network connection for one or more applications predetermined by the each level. Also, The wireless terminal apparatus 300 cutoffs the network connection for a part of each application by the each level.

Further, using the network usage cutoff policy information, the wireless terminal apparatus 300 selectively cutoffs at least one of background applications and foreground applications. And the wireless terminal apparatus 300 can select cutoff target applications (foreground, background or both of them) by the traffic level information. Therefore, the policy sever 100 can control traffic amount for each by each of the wireless terminal apparatus 300 using the traffic level information and can selectively cutoff applications or a part of applications by the traffic level information.

According to an embodiment of the present invention, the present invention may cutoff unnecessary network connection trial itself performed by the applications disposed at the wireless terminal apparatus that may not transceiver data even on trying the network connection in the overloaded area.

According to another embodiment of the present invention, the present invention may cutoff excessive network connection trial itself performed by the applications disposed at the wireless terminal apparatus driven in the overloaded area, thereby to solve the overload and optimize network usage at wireless terminal apparatus stages.

Further, According to further another embodiment of the present invention, the present invention may automatically clear network usage cutoff on arriving on the time set to the timer for clearing the network usage cutoff, thereby to solve inconvenience transmitting the policy information for clearing the network usage cutoff to the user's wireless terminal apparatus one by one.

According to further yet another embodiment of the present invention, mobile-service company's network expansion cost may be minimized by optimizing network usage.

According to further yet another embodiment of the present invention, on optimizing the network usage, it is possible to minimize dissatisfaction for the user of the wireless terminal apparatus caused by data communication delay, etc. and to greatly reduce battery consumption for the wireless terminal apparatus.

What is claimed is:

1. A system for operating network traffic reduction policy in an overloaded area, comprising:
a storage medium for storing policy agent identification information disposed at a wireless terminal apparatus in response to the wireless terminal apparatus identification information;
a communication unit for receiving the wireless terminal apparatus identification information positioned at an overloaded area from a communication server;
a confirmation unit for confirming the policy agent identification information disposed at the wireless terminal apparatus corresponding to the received wireless terminal apparatus identification information by the storage medium; and
a processing unit for transmitting network usage cutoff policy information included with a timer for clearing network usage cutoff to policy agents corresponding to the policy agent identification information confirmed by the confirmation unit.

2. The system for operating the network traffic reduction policy in the overloaded area according to claim 1, wherein the network usage cutoff policy information includes the policy information for cut-offing network connection, during constant time defined by the timer, for the remaining applications, except for the predefined specific applications, of a plurality of network usage applications disposed at the wireless terminal apparatus.

3. The system for operating the network traffic reduction policy in the overloaded area according to claim 1, wherein
the communication unit further receives the wireless terminal apparatus identification information positioned at an area deviated or cleared from the overloaded area from a server on a communication network,
the confirmation further confirms the policy agent identification information disposed at the wireless terminal apparatus in response to the further received wireless terminal apparatus identification information by the storage medium, and
the processing unit transmits the policy information for clearing the network usage cutoff to the policy agents corresponding to the policy agent identification information further confirmed by the confirmation unit when time further receiving the wireless terminal apparatus identification information is within time, defined by the timer for clearing the network usage cutoff, already transmitted to the policy agents.

4. The system for operating the network traffic reduction policy in the overloaded area according to claim 1, wherein the processing unit transmits the application identification information allowing the network usage irrespective the position of the wireless terminal apparatus in the overloaded area to the policy agents.

5. The system for operating the network traffic reduction policy in the overloaded area according to claim 1, wherein
the processing unit transmits the policy information for clearing the network usage cutoff to the policy agents, in case of further receiving at least one of the user's wireless terminal apparatus identification information deviated from the overloaded area from the communication server and the user's wireless terminal apparatus identification information positioned at the area at the time of clearing overload in the overloaded area, within time defined by the timer for clearing the network usage cutoff, and
the policy agents clears the network connection cutoff for the specific applications on arriving on the time defined to the timer for clearing the network usage cutoff, in case of not receiving the policy information for clearing the network usage cutoff, within the time set to the timer for clearing the network connection cutoff.

6. The system for operating the network traffic reduction policy in the overloaded area according to claim 1, wherein the policy agents confirms the current position information and whether the current position deviates the overloaded area before arriving on the time defined by the timer for clearing the network usage cutoff, clears the network connection cutoff for the applications by the policy agents disposed at the wireless terminal apparatus, in the case that the current position deviates the overloaded area, after the confirming, and clears the network connection cutoff for the applications on arriving on the time defined by the timer for clearing the network usage cutoff, in the case that the current position does not deviate the overloaded area, after the confirming.

7. A method for operating network traffic reduction policy in an overloaded area, comprising:
storing policy agent identification information disposed at a wireless terminal apparatus in response to the wireless terminal apparatus identification information;
receiving the wireless terminal apparatus identification information positioned at an overloaded area from a communication server;
confirming the policy agent identification information disposed at the wireless terminal apparatus corresponding to the received wireless terminal apparatus identification information by the storage medium; and
transmitting network usage cutoff policy information included with a timer for clearing network usage cutoff to policy agents corresponding to the confirmed policy agent identification information.

8. The method for operating the network traffic reduction policy in the overloaded area according to claim 7, wherein the network usage cutoff policy information includes the policy information for cut-offing network connection, during constant time defined by the timer, for the remaining applications, except for the predefined specific applications, of a plurality of network usage applications disposed at the wireless terminal apparatus.

9. The method for operating the network traffic reduction policy in the overloaded area according to claim 7, further comprising
receiving the wireless terminal apparatus identification information positioned at an area deviated or cleared from the overloaded area from the communication server,
confirming the policy agent identification information disposed at the wireless terminal apparatus in response to the received wireless terminal apparatus identification information by the storage medium, and
transmitting the policy information for clearing the network usage cutoff to the policy agents corresponding to the policy agent identification information further confirmed by the confirmation unit when time further receiving the wireless terminal apparatus identification information is within time, defined by the timer for clearing the network usage cutoff, already transmitted to the policy agents.

10. The method for operating the network traffic reduction policy in the overloaded area according to claim 7, further comprising transmitting the application identification information allowing the network usage irrespective the position of the wireless terminal apparatus in the overloaded area to the policy agents.

11. The method for operating the network traffic reduction policy in the overloaded area according to claim 7, further comprising
transmitting the policy information for clearing the network usage cutoff to the policy agents, in case of further receiving at least one of the user's wireless terminal apparatus identification information deviated from the overloaded area from the communication server and the user's wireless terminal apparatus identification information positioned at the area at the time of clearing overload at the overloaded area, within time defined by the timer for clearing the network usage cutoff,
wherein the policy agents clears the network connection cutoff for the specific applications on arriving on the time defined to the timer for clearing the network usage cutoff, in case of not receiving the policy information for clearing the network usage cutoff, within the time set to the timer for clearing the network usage cutoff.

12. The method for operating the network traffic reduction policy in the overloaded area according to claim 7, wherein the policy agents confirms the current position information and whether the current position deviates the overloaded area before arriving on the time defined by the timer for clearing the network usage cutoff, clears the network connection cutoff for the applications by the policy agents disposed at the wireless terminal apparatus, in the case that the current position deviates the overloaded area, after the confirming, and clears the network connection cutoff for the applications on arriving on the time defined by the timer for clearing the network usage cutoff, in the case that the current position does not deviate the overloaded area, after the confirming.

13. A computer-readable recording medium for recording programs to perform a method of claim 7.
